(19) United States
(12) Patent Application Publication
(10) Pub. No.: US 2025/0188325 A1
(43) Pub. Date: Jun. 12, 2025

(54) POSITIVELY CHARGED ADHESIVES

(71) Applicant: Purdue Research Foundation, West Lafayette, IN (US)

(72) Inventors: Jonathan J. WILKER, West Lafayette, IN (US); Jennifer Marie GARCIA RODRIGUEZ, Lafayette, IN (US)

(21) Appl. No.: 18/856,018

(22) PCT Filed: Apr. 20, 2023
(86) PCT No.: PCT/US2023/019234

§ 371 Date: Oct. 10, 2024

Related U.S. Application Data
(60) Provisional application No. 63/333,613, filed on Apr. 22, 2022.

(51) Int. Cl. C09J 133/26; C08F 220/14; C08F 220/60

(52) U.S. Cl. CPC C09J 133/26; C08F 220/14; C08F 220/606; C08F 2800/10; C08F 2810/20

(57) ABSTRACT

A positively charged adhesive polymer comprising (i) a catechol-containing monomer, (ii) a filler monomer, and (iii) a cation-containing monomer, its use in dry and wet (e.g., damp, wet and underwater) adhesion, and its synthesis.

### CROSS-REFERENCE TO RELATED APPLICATION

This application claims priority to U.S. provisional patent application No. 63/333,613, which was filed Apr. 22, 2022, and which is incorporated herein by reference in its entirety.

### STATEMENT OF GOVERNMENT SUPPORT

This invention was made with government support under N00014-19-1-2342 awarded by the Office of Naval Research. The government has certain rights in the invention.

### TECHNICAL FIELD

The present disclosure relates to positively charged adhesive polymers, which can be used on dry, damp, wet, and underwater surfaces, and a method of synthesizing such polymers.

### BACKGROUND

This section introduces aspects that may help facilitate a better understanding of the disclosure. Accordingly, these statements are to be read in this light and are not to be understood as admissions about what is or is not prior art.

Marine mussels have been providing blueprints for the design of several new adhesives. They can stick on wet environments by using 3,4-dihydroxy-1-phenylalanine (DOPA). Their protein-based glue has cationic amino acids such as arginine and lysine. Most mussel adhesive proteins are cationic, i.e., positively charged. The biomimetic systems often incorporate catechol groups to provide strong adhesion in both dry and wet environments. However, catechol groups are sensitive to temperature, pH, and oxidation, limiting their application and long-term stability. Hence, potential roles for cations in adhesion have been studied at the nanoscale level. They improve the cohesion strength by penetrating the surface hydration layer move through hydrated ions and cation-pi interactions, which are important for cohesive bonding.

Thus, there is an unmet need for a biomimetic adhesive polymer that combines a catechol group and positive charges to provide strong bonding and stability. It is an object of the present disclosure to provide such a biomimetic adhesive polymer. This and other objects and advantages, as well as inventive features, will be apparent from the detailed description.

### SUMMARY

Provided is an adhesive polymer comprising (i) a catechol-containing monomer, (ii) a filler monomer, and (iii) a cation-containing monomer. The adhesive polymer is a positively charged polymer comprising quaternary alkyl ammonium cation.

In some embodiments, the cation-containing monomer is selected from [3-(methacryloylamino)propyl] trimethylammonium chloride (MAPTAC), [2-(methacryloyloxy)ethyl] trimethylammonium chloride (METAC), and (3-acrylamidopropyl) trimethylammonium chloride (APTAC). The cation-containing monomer is present in a proportion of about 5 mol % to about 80 mol % of the polymer.

In some embodiments, the catechol-containing monomer is selected from dopamine acrylamide (DA) and dopamine methacrylamide (DMA). The catechol-containing monomer is present in a proportion of about 10 mol % of the polymer.

In some embodiments, the filler monomer is selected from methyl acrylate (MA), methyl methacrylate (MMA) and N-[3-(dimethylamino)propyl] methacrylamide (DMAPMA). The filler monomer is present in a proportion of about 85 mol % to about 10 mol % of the polymer.

In some embodiments, the adhesive polymer can further comprises a cross-linker. The cross-linker used is sodium periodate, tetrabutylammonium periodate, iron(III) nitrate, iron(III) acetonylacetonate, potassium permanganate, di-tert-butyl peroxide, hydrogen peroxide, cumene hydroperoxide, 2-butanone hydroperoxide, potassium ferrate, chromate, dichromate, or any combination thereof.

Provided is a method of synthesizing the adhesive polymer, wherein the synthesis comprises:
(i) dissolving a catechol-containing monomer with a filler monomer and an initiator in a non-aqueous solvent to provide a solution of monomers;
(ii) mixing an aqueous solution of cation-containing monomer with the solution of monomers of step (i);
(iii) allowing a polymerization reaction to occur; and
(iv) quenching the polymerization reaction to obtain the adhesive polymer.

The non-aqueous solvent used in step (i) is selected from methanol, dichloromethane, chloroform, N, N dimethylformamide, acetone, acetonitrile, dimethylsulfoxide or a combination thereof. In some embodiments, methanol and water are used in a ratio of about 70:30 v/v.

In some embodiments, the initiator is selected from dibenzoyl peroxide (BPO), tert-butyl peroxide, diacetyl peroxide, lauroyl peroxide, dicumyl peroxide, 2,2′-azobisisobutyronitrile (AIBN), 2,2′-azobis(2-methylpropionitrile), 2,2′-azobis(2-methyl butyronitrile), or a combination thereof.

### BRIEF DESCRIPTION OF THE DRAWINGS

The present disclosure will be more readily understood from the detailed description of embodiments presented below, considered in conjunction with the attached drawings of which:

FIG. 1A shows dry adhesion data for derivatives of p[dopamine methacrylamide-co-methyl methacrylate-co-[3-(methacryloylamino)propyl] trimethylammonium chloride] (p[DMA-MMA-MAPTAC]) without periodate cross-linker.

FIG. 1B shows dry adhesion data for derivatives of p[DMA-MMA-MAPTAC] with periodate cross-linker.

FIG. 2A shows underwater adhesion data for p[DMA-MMA-MAPTAC] under salt water.

FIG. 2B shows underwater adhesion data for p[DMA-MMA-MAPTAC] under deionized water.

FIG. 3A shows contact angles in dry adhesion for p[DMA-MMA-MAPTAC].

FIG. 3B shows contact angles under salt water for p[DMA-MMA-MAPTAC]. The higher cation content gives rise to a higher contact angle.

### DETAILED DESCRIPTION

For the purposes of promoting an understanding of the principles of the present disclosure, reference will now be made to the embodiments illustrated in the drawings, and specific language will be used to describe the same. No limitation of scope is intended by the description of these embodiments. On the contrary, this disclosure is intended to cover alternatives, modifications, and equivalents as may be included within the spirit and scope of this application as defined by the appended claims.

The terms “adhesive polymer,” “polymer,” and “adhesive” are used interchangeably.

The terms “positive charges” and “cations” are used interchangeably.

Provided is an adhesive polymer comprising (i) a catechol-containing monomer, (ii) a filler monomer, and (iii) a cation-containing monomer. In embodiments thereof, the adhesive polymer consists essentially of, or consists of, (i)-(iii).

In some embodiments, the adhesive polymer is a positively charged adhesive polymer comprising (i) a catechol-containing monomer, (ii) a filler monomer, and (iii) a cationic ammonium-containing monomer. The positively charged adhesive polymer is a biomimetic polymer containing one or more catechol groups and varying content of cations, for example, quaternary ammonium groups. These quaternary ammonium cations are positively charged ions that influence cohesive bonding versus surface interactions in biomimetic adhesives and can provide strong adhesion.

The cationic ammonium-containing monomer can be selected from [3-(methacryloylamino)propyl] trimethylammonium chloride (MAPTAC), [2-(methacryloyloxy)ethyl] trimethylammonium chloride (METAC), and (3-acrylamidopropyl) trimethylammonium chloride (APTAC). These monomers comprise the quaternary alkyl ammonium group as a positive charge.

In some embodiments, the cationic ammonium-containing monomer is present in a proportion of about 5 mol % to about 80 mol % of the polymer (such as about 5 mol % to 80 mol %, 5 mol % to about 80 mol %, or 5 mol % to 80 mol %). Preferably, the cationic ammonium-containing monomer is present in a proportion of about 10 mol % to about 76 mol % of the polymer (such as about 10 mol % to 76 mol %, 10 mol % to about 76 mol %, or 10 mol % to 76 mol %).

The catechol-containing monomer can be any suitable monomer comprising a catechol unit (3,4-dihydroxy phenyl ring). It acts as an adhesive in the polymer. In exemplary embodiments, the catechol-containing monomer is selected from dopamine acrylamide (DA) and dopamine methacrylamide (DMA).

In some embodiments, the amount of catechol-containing monomer present is about 10 mol % (such as 10 mol %) of the polymer. The content of the catechol-containing monomer can be kept constant and not varied.

The filler monomer can fill the remainder of the polymer composition as needed. The filler monomer can be selected from methyl acrylate (MA), methyl methacrylate (MMA), and N-[3-(dimethylamino)propyl] methacrylamide (DMAPMA).

In some embodiments, the amount of filler monomer present is in a proportion of about 85 mol % to about 10 mol % of the polymer (such as about 85 mol % to 10 mol %, 85 mol % to about 10 mol %, or 85 mol % to 10 mol %), such as about 80 mol % to about 14 mol % of the polymer (such as about 80 mol % to 14 mol %, 80 mol % to about 14 mol %, or 80 mol % to 14 mol %).

In some embodiments, the adhesive polymer can further comprise a cross-linker. In embodiments thereof, the adhesive polymer can further consist essentially of (or can further consist of) a cross-linker.

The suitable cross-linker can be a periodate oxidative cross-linker. Periodate cross-linkers are known to improve the adhesion of catechol-based synthetic polymers. Examples of the periodate oxidative cross-linker include, but are not limited to, sodium periodate, tetrabutylammonium periodate, iron(III) nitrate, iron(III) acetonylacetonate, potassium permanganate, di-tert-butyl peroxide, hydrogen peroxide, cumene hydroperoxide, 2-butanone hydroperoxide, potassium ferrate, chromate, dichromate, or any combination thereof. The amount of catechol-containing monomer and cross-linker (catechol:IO₄⁻) used can be in a molar ratio of about 3:1 v/v (such as 3:1 v/v).

The molecular weight of the adhesive polymer, for example, p[DMA-co-MMA-co-MAPTAC] can be about 200,000 g/mol or less (see Table 1). In some embodiments, the molecular weight of the polymer can range from about 10,000 g/mol to about 200,000 g/mol (such as about 10,000 g/mol to 200,000 g/mol, 10,000 g/mol to about 200,000 g/mol, or 10,000 g/mol to 200,000 g/mol). In some embodiments, the molecular weight can range from about 14,000 g/mol to about 105,000 g/mol (such as about 14,000 g/mol to 105,000 g/mol, 14,000 g/mol to about 105,000 g/mol, or 14,000 g/mol to 105,000 g/mol). In some embodiments, the number average molecular weight (Mn) can range from about 5,000 g/mol to about 40,000 g/mol (such as about 5,000 g/mol to 40,000 g/mol, 5,000 g/mol to about 40,000 g/mol, or 5,000 g/mol to 40,000 g/mol), such as from about 6,000 g/mol to about 35,000 g/mol (such as about 6,000 g/mol to 35,000 g/mol, 6,000 g/mol to about 35,000 g/mol, or 6,000 g/mol to 35,000 g/mol). Table 1 shows that the molecular weights increase as the content of the positive charge increases.

Table 1 indicates that the polydispersity of all polymers is above 2. Adhesives with higher polydispersities can provide better adhesion. Varied amounts of short and long chains can generate a good balance of cohesive and adhesive forces in the glue. Along with the polydispersity, high total molecular weights in catechol systems can increase adhesion strength. In some embodiments, the polydispersity of polymers ranges from about 2 to about 4, such as from about 2 to 4, from 2 to about 4, or from 2 to 4.

The positively charged adhesive polymer can be synthesized by radical polymerization. This is a reproducible synthesis for large-scale production. The polymer obtained can have high polydispersity. The synthesis involves the polymerization of three types of monomers: (i) a catechol-containing monomer (ii) a cation-containing monomer, and (iii) a filler monomer in the presence of an initiator.

In some embodiments, the synthesis comprises the following steps:
(i) dissolving a catechol-containing monomer with a filler monomer and an initiator in a non-aqueous solvent to provide a solution of monomers;
(ii) mixing an aqueous solution of a cation-containing monomer with the solution of monomers of step (i);
(iii) allowing a polymerization reaction to occur; and
(iv) quenching the polymerization reaction to obtain said the adhesive polymer.

Any suitable initiator can be used. The initiator can be, for example, 2,2,6,6-tetramethyl-1-piperidinyloxy (TEMPO) for a nitroxide-mediated radical initiation; an arenesulfonyl chloride with a metal catalyst or an alkyl halide with a transition metal catalyst for atom transfer radical addition polymerization (ATRP); a reversible addition-fragmentation chain transfer (RAFT) agent; or ultraviolet (UV) light. In some embodiments, radical polymerization is a free radical polymerization.

An initiator for a free radical polymerization can be selected from dibenzoyl peroxide (BPO), tert-butyl peroxide, diacetyl peroxide, lauroyl peroxide, dicumyl peroxide, 2,2′-azobisisobutyronitrile (AIBN), 2,2′-azobis(2-methylpropionitrile), 2,2′-azobis(2-methyl butyronitrile), or a combination of two or more thereof. In some embodiments, it can be desirable to use AIBN as the initiator.

The solvent used can be any suitable solvent that can dissolve the polymer. Examples of the solvent include, but are not limited to, methanol, water, dichloromethane, chloroform, N, N dimethylformamide, acetone, acetonitrile, dimethylsulfoxide or a combination of two or more solvents. In some embodiments, the suitable solvent is a combination of methanol and water. The ratio of methanol and water used can be about 70:30 v/v (such as 70:30 v/v).

Provided is an adhesive polymer composition comprising (i) a catechol-containing monomer, (ii) a filler monomer, (iii) a cation-containing monomer, and (iii) an organic solvent. In embodiments thereof, the adhesive polymer composition consists essentially of, or consists of, (i)-(iii).

In some embodiments, the adhesive polymer composition can further comprise a cross-linker. In embodiments thereof, the adhesive polymer composition can further consist essentially of (or can further consist of) a cross-linker.

The polymer adhesive composition can be used in a solution form. The polymer adhesive can be dissolved in an organic solvent. The organic solvent can be any suitable solvent that is denser than the water such that the polymer adhesive does not float up and off the substrate. The organic solvent can be selected from methanol, acetone, chloroform, acetonitrile, dichloromethane, N, N dimethylformamide, dimethylsulfoxide, and any combination thereof. This polymer solution can be deposited onto both substrates separately, and the substrates can be overlapped to form a single lap shear joint.

Advantageously, the adhesive polymer can work in a dry environment, underwater, or on damp or wet surfaces. Typical adhesives known in the art work in dry environments but do not work when applied underwater or on wet surfaces. Dry adhesives known in the art do not show strong bonding underwater or on wet surfaces.

The adhesive polymer can be used in any kind of water, such as fresh water or salt water. The substrates can be submerged underwater during the application of the polymer adhesive or after the application.

Structure-function studies for positively charged polymers were carried out to examine adhesion in dry and underwater conditions. A low amount of positive charge into these catechol-containing polymers was observed to have aided bulk adhesion strengths. On the other hand, too much positive charge generated the opposite effect, with bond strengths dropping. Although too high positive charge content resulted in decreased bulk adhesion, surface bonding was observed to increase consistently with an added positive charge. The positive charge in the polymer increases its hydrophilicity. When working under salt water, these positive charges can confer an increase in adhesion. Although when the positive charge content was high, the polymer became soluble in water. Thus, these cations can influence adhesion by enhancing interactions at the surface. Such increased bonding, however, comes at the expense of weakened cohesive bonding within the bulk material.

The adhesion studies were performed using aluminum substrates (6061-T6) that were strips cut using snip scissors (8.90×1.27×0.16 cm). All joints were cured at room temperature for 1 h, then 70° C. in an oven for 22 h, followed by 1 h cooling at room temperature. Lap shear bond strengths were measured using an Instron 5544 Materials Testing System with a 2000 N load cell. Adhesion was determined by dividing the maximum force at failure (N) by the substrate overlap area (m2). Error bars show 90% confidence intervals.

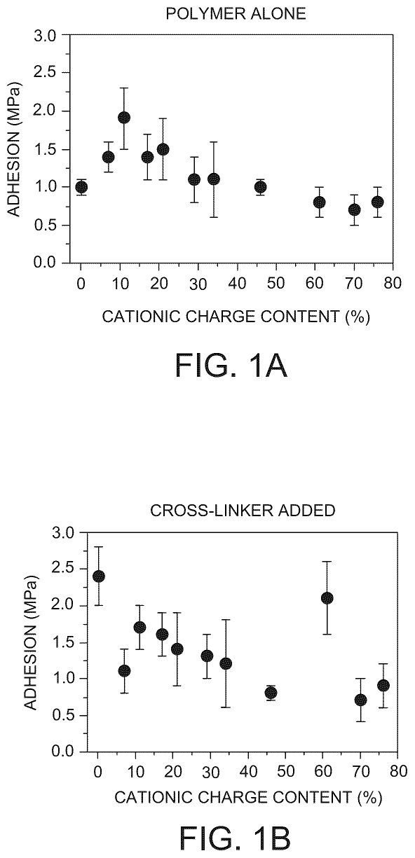

FIG. 1A shows that the control polymer alone e.g., p[DMA-MMA-MAPTAC] without a positive charge bonded with dry surface and adhesion starts at 1.0 (±0.1) MPa. Adding cations to the polymer that has no charge increased adhesion until it peaked at 11% charge with 1.9 (±0.4) MPa. Further cation addition decreased adhesion down to ˜0.8 MPa with the polymers containing 61% to 76% cationic charge. When the IO4⁻ cross-linker was added, the polymer adhesion bonded at 2.4 (±0.4) MPa. In FIG. 1B, adding positive charges showed a less obvious trend than the analogous polymer without the cross-linker (FIG. 1A). Thus, added cations showed decreased adhesion when cross-linked. The polymer containing 61% positive charge showed adhesion of 2.1 (±0.5) MPa.

These results indicate that for dry bonding of adhesive polymer with no cross-linker small degrees of charge inclusion increased bonding. Larger loadings of cations produced the opposite effect, and performance decreased. When cross-linker was incorporated, the general broad trend was lower adhesion with more cations, i.e., cations do not appear to be a significant promoter of adhesion when cross-linked.

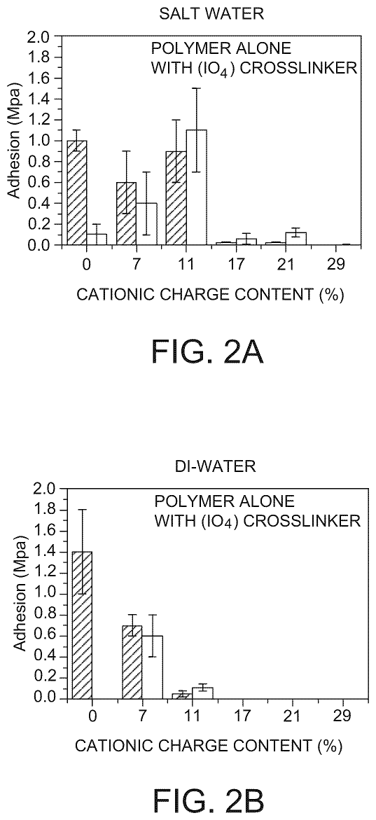

FIG. 2A shows the adhesion data for adhesive polymer under salt water. The data were collected from the 0-29% positive charge content in the polymer. The uncharged control polymer (1.0±0.1 MPa) showed similar adhesion to the dry conditions at 1.0 (±0.1) MPa. Bonding of the 7% cationic charge shows adhesion of 0.6±0.3 MPa. Higher adhesion was then seen for 11% cation content, 0.9±0.3 MPa. Above 11%, the adhesion decreased significantly to less than ˜0.2 MPa. The study concludes that cationic charges aid in underwater adhesion.

### EXAMPLES

### Materials

Methanol (MeOH, 99.8%, Aldrich), ethyl ether (99%, Fisher), ethyl acetate (EtOAc, Fisher) dichloromethane (DCM, Fisher), N,N-dimethyl formamide (DMF, 99.8%, Aldrich) and [2-(methacryloyloxy)ethyl] trimethylammonium chloride (METAC, 75 wt % in H2O, Aldrich), 2,2′-azobis(2-methylpropionitrile) (AIBN, 98%, Aldrich) Methyl acrylate (MA, 99%, Aldrich), methyl methacrylate (MMA, 99%, Aldrich) and N-[3-(dimethylamino)propyl] methacrylamide (DMAPMA, 99%, Aldrich), [3-(methacryloylamino)propyl] trimethylammonium chloride (MAPTAC, 50 wt % in H2O, Aldrich) and (3-acrylamidopropyl) trimethylammonium chloride (APTAC, 75 wt % in H2O, Aldrich).

Dopamine methacrylamide (DMA) was made following a literature procedure (Lee, H. et al., Nature 2007, 448 (7151), 338-341).

### Characterization

Polymers were characterized with ¹H nuclear magnetic resonance (NMR) spectroscopy using a Varian Inova-300 MHz spectrometer. Molecular weights and polydispersities were acquired by gel permeation chromatography (GPC) on an Agilent 1260 Infinity II liquid chromatography system. The mobile phase consisted of 20% MeOH in deionized water with 0.5 M sodium acetate/acetic acid. The control polymer sample was acquired in a THF mobile phase. The column used was a Tosoh Bioscience TSKgel Alpha-M, 13 μm, 7.8 mm ID×30 cm with a TSKgel Alpha guard column 13 μm, 6.0 mm ID×4 cm. The column used for the control polymer was a two Waters Styragel HR 5E, mixed bed, 5 μm, 7.8 mm×300 mm in THF, 2K-4M connected in series with a Waters Styragel HR GPC Guard Column, 20 μm, 4.6 mm×30 mm in THF, 100-10,000K. The calibration standard for the buffered mobile phase was polyethylene oxide/polyethylene glycol. The THF mobile phase calibration standard was styrene. Deionized water was from a Barnstead Nanopure Infinity Ultrapure water system with a final resistivity of 17.8 MΩ. Artificial sea water was prepared from Marine Environment dual-phase formula dissolved into deionized water to a final salinity of 33 g/kg.

### Synthesis:

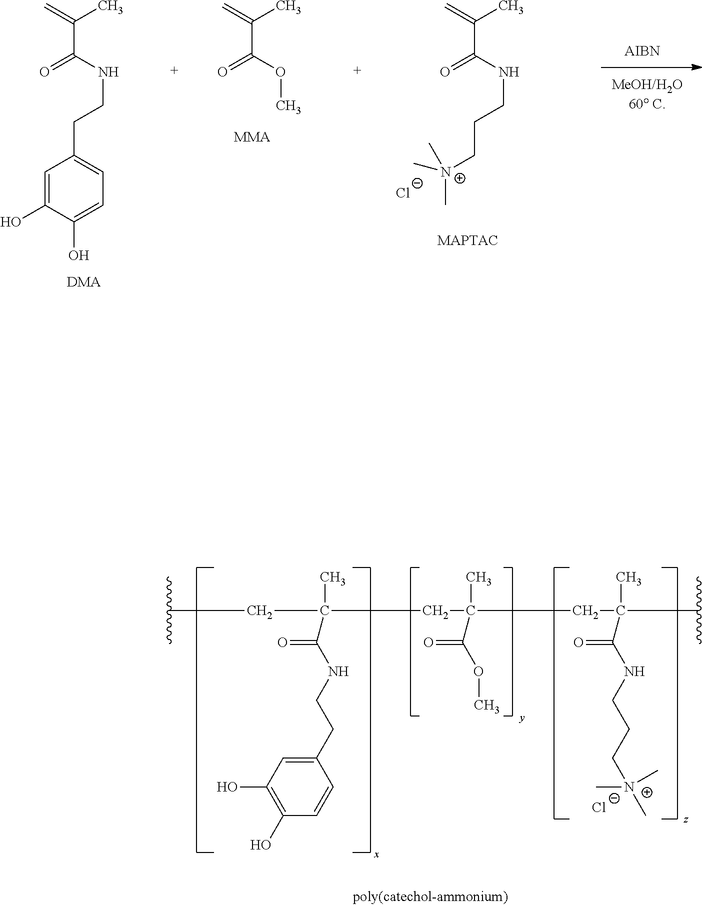

### Synthesis of p[dopamine methacrylamide-co-methyl methacrylate-co-[3-(methacryloylamino)propyl] trimethylammonium chloride] (p[(DMA-co-MMA-co-METAC])

### Example 1

### Synthesis of p[dopamine methacrylamide-co-methyl methacrylate-co-[2-(methacryloyloxy)ethyl] trimethylammonium chloride] (p[DMA-co-MMA-co-METAC])

A typical radical polymerization without previous purification of [2-(methacryloyloxy)ethyl] trimethylammonium chloride (METAC) included 0.166 g (0.75 mmol) of dopamine methacrylamide (DMA), 0.64 mL (0.64 mmol) of methyl methacrylate (MMA), 0.19 mL (0.75 mmol) of METAC and 150 mg (0.9 mmol) of 2,2′-azobis(2-methylpropionitrile) (AIBN) in 14 mL of anhydrous methanol solvent at 60° C. under argon for 48 h. The polymer solution was precipitated with cold ether three times and dried in vacuo, yielding a white solid.

¹H NMR (CD₃OD, 300 Hz): δ 0.74-1.14 (br, methyl, carbon backbone, —CCH3), 1.76-2.20 (br, polymer backbone, —CCH2), 3.20-3.22 (br, —N(CH3)3), 3.55-3.75 (br, —OCH3), 6.50-6.82 (br, aromatic).

### Example 2

### Synthesis of p[dopamine methacrylamide-co-methyl methacrylate-co-N-[3-(dimethylamino)propyl] methacrylamide] (p[DMA-co-MMA-co-DMAPMA])

To synthesize a tertiary amine terpolymer precursor for a quaternary ammonium charged system, 0.443 g (2 mmol) of dopamine methacrylamide (DMA), 1.7 mL (16 mmol) of methyl methacrylate (MMA), 0.36 mL (2 mmol) of N-[3-(dimethylamino)propyl] methacrylamide (DMAPMA) and 32.8 mg (0.2 mmol) of 2,2′-azobis(2-methylpropionitrile) (AIBN) were dissolved in 24 mL of N,N-dimethyl formamide solvent at 70° C. for 48 h. The reaction was quenched with methanol and the polymer solution was precipitated with cold ether. The product was reprecipitated two additional times in dichloromethane:methanol/ether and dried in vacuo, yielding a white solid.

### Example 3

### Synthesis of p[dopamine methacrylamide-co-methyl methacrylate] (p[DMA-co-MMA])

A typical synthesis included 0.664 g (3 mmol) of dopamine methacrylamide (DMA), 1.702 g (17 mmol) of methyl methacrylate (MMA), and 32.8 mg (0.2 mmol) of 2,2′-azobis(2-methylpropionitrile) (AIBN) dissolved in 24 mL of anhydrous methanol in a 50 ml Schlenk flask. The reaction mixture is left bubbling in Argon for 30 mins and left to stir in an oil bath at 70° C. for 48 h. The polymer solution was precipitated with cold ether. The product was reprecipitated two additional times in methanol/ether and dried in vacuo, yielding a white solid.

Control polymer: ¹H NMR (300 Hz, DMSO-d6, δ): 61-1.00 (broad, methyl, carbon backbone, —CCH3), 1.49-2.04 (broad, polymer backbone, —CCH2), 3.45-3.62 (broad, —OCH3), 6.36-6.67 (broad, aromatic).

### Example 4

### Synthesis of p[dopamine methacrylamide-co-methyl methacrylate-co-[3-(methacryloylamino)propyl] trimethylammonium chloride] (p[DMA-co-MMA-co-MAPTAC]); p[dopamine methacrylamide-co-methyl methacrylate-co-(3-acrylamidopropyl) trimethylammonium chloride] (p[DMA-co-MMA-co-APTAC]); and

### p[dopamine methacrylamide-co-methyl acrylate-co-(3-acrylamidopropyl) trimethylammonium chloride] (p[DMA-co-MA-co-APTAC])

The polymers were synthesized following the same procedure with different monomers combinations. The reactions were carried out in methanol:water (24 mL, 70:30 v/v). A typical synthesis included 0.443 g (2 mmol) of dopamine methacrylamide (DMA), 1.602 g (16 mmol) of methyl methacrylate (MMA), and 32.8 mg (0.2 mmol) of 2,2′-azobis(2-methylpropionitrile) (AIBN) dissolved in 16.8 mL of anhydrous methanol and mixed in a Schlenk flask with the aqueous phase of previously purified 0.883 g (2 mmol) of [3-(methacryloylamino)propyl] trimethylammonium chloride (MAPTAC) in 7.2 mL of water washed with ethyl acetate (3×3.6 mL). The reaction mixture was left bubbling in argon for 30 mins and left to stir in an oil bath at 70° C. for 48 h. The reaction was quenched with methanol and the polymer solution was precipitated with cold ether. The product was reprecipitated two additional times in methanol/ether and dried in vacuo, yielding a white solid.

For the 11% cationic polymer: ¹H NMR (300 Hz, CD3OD-d4, δ): 0.78-1.13 (broad, methyl, carbon backbone, —CCH3), 1.59-2.24 (broad, polymer backbone, —CCH2), 3.13-3.24 (broad, —N(CH3)3), 3.54-3.74 (broad, —OCH3), 6.50-6.83 (broad, aromatic).

TABLE 1
Feed and incorporation ratios plus molecular weight data of p[DMA-co-MMA-co-MAPTAC]

| | Feed % | | | Incorporation % | | | | | |
|---|---|---|---|---|---|---|---|---|---|
| | Catechol | Filler | Ammonium | Catechol | Filler | Ammonium | | | |
| entry | (DMA) | (MMA) | (MAPTAC) | (DMA) | (MMA) | (MAPTAC) | Mn | Mw | Ð |
| (1) | 15 | 85 | 0 | 15 | 85 | 0 | 24,200† | 71,700† | 3.0† |
| (2) | 10 | 80 | 10 | 13 | 76 | 11 | * | * | * |
| (3) | 10 | 70 | 20 | 13 | 66 | 21 | * | * | * |
| (4) | 10 | 60 | 30 | 13 | 53 | 34 | 6,000 | 14,700 | 2.5 |
| (5) | 10 | 50 | 40 | 13 | 41 | 46 | 11,200 | 34,800 | 3.3 |
| (6) | 10 | 40 | 50 | 13 | 26 | 61 | 11,500 | 30,000 | 2.6 |
| (7) | 10 | 30 | 60 | 12 | 18 | 70 | 23,400 | 87,800 | 3.8 |
| (8) | 10 | 20 | 70 | 11 | 13 | 76 | 30,800 | 102,900 | 3.3 |

*Not soluble in 20% MeOH in water with 0.5M acetic acid/sodium acetate. †Control was dissolved in THF for GPC characterization.

Each of the polymers described in Table 1 were characterized by ¹H NMR spectroscopy to determine the percentage of each monomer. The molecular weight and polydispersity data were obtained from GPC. Given the solubility constraints of the cationic polymers, an aqueous buffered mobile phase was required for GPC characterization. The uncharged control polymer GPC data were determined in THF mobile phase due to solubility. The polymers with 7% and 11% cationic charge were neither soluble in buffered water nor THD, thereby making GPC characterization impractical. These low charge loadings molecular weights were not determined. The reaction was carried in MeOH/Water 70:30 v/v, as the cationic monomer content was increased, the reaction conditions were more favorable, as it minimized chain termination. The control polymer (Table 1, Entry 1) reaction was carried in MeOH, with a higher molecular weight than that of 30% cationic charge (Table 1, Entry 4). The lower molecular weight can be caused by the water in the reaction inducing early chain termination.

### Adhesion Studies

Bulk lap shear adhesion tests were performed using aluminum substrates (6061-T6) purchased from McMaster-Carr that were precision cut using a water jet to 8.9×1.2×0.3 cm dimensions. These substrates were cleaned before use according to a modified version of ASTM D2651-01 standard etching method, followed by washes in hot base and acid baths, methanol, and boiling water. Unless otherwise noted, polymers were dissolved at 0.3 g/mL in MeOH/DCM (70:30 v/v) with sonication to aid solubility. Polymer solutions (45 μL) were deposited onto each substrate and overlapped (1.2×1.2 cm) to form single lap joints. When used, 15 μL of tetrabutylammonium periodate [N(C4H9)4](IO4) cross-linker solution was used at a 3:1 molar ratio catechol:cross-linker in MeOH/DCM (70:30 v/v). All joints were cured at room temperature for 1 h, then 70° C. in an oven for 22 h, followed by 1 h cooling at room temperature. Lap shear bond strengths were measured using an Instron 5544 Materials Testing System with a 2000 N load cell. Adhesion was determined by dividing the maximum force at failure (N) by the substrate overlap area (m2). Error bars show 90% confidence intervals. Adhesive strength was initially determined using an Instron 5544 using a 2 kN load cell that was properly calibrated. The majority of samples tested breached the load cell capacity, so they were tested on an MTS Insight materials testing instrument with a 10 kN load cell. Samples for both the Instron and MTS were placed in the instrument using two steel crossbars to hold each adherend in place. The lap-shear joints were then pulled on the instrument using a pull rate of 2 mm/min. The force applied on the joints was recorded in Newtons (N). The resulting adhesive strength in units of megapascal (MPa) was calculated by dividing the force (N) and the resulting overlap area (mm²).

### Underwater Adhesion Studies

Lap shear adhesion measurements were carried out under artificial seawater with 33 g/kg salinity and also deionized water. The tests were performed using aluminum substrates (6061-T6) that were strips cut using snip scissors (8.90×1.27×0.16 cm). These substrates were cleaned before use with hexanes, acetone, methanol, and water and dried at 100° C. for 24 hrs. To test adhesion underwater, a solvent mixture with a higher ratio of dichloromethane over methanol (DCM/MeOH 3:1 v/v) was chosen to dissolve the polymers given the higher density than water, allowing the solutions to stay submerged. As the cationic charge content increased, a minimal amount of methanol was used to help with solubility. Polymer solutions (45 μL) were brought underwater, in a syringe, and deposited on the substrates submerged in water. A second adherend was brought underwater and placed on top (1.27×1.27 cm) to form a single lap shear joint. A 55 g weight (15 mL centrifuged tube filled with lead shots) was added to aid stability. When used, the cross-linker concentration and volume were the same as those used for the dry adhesion testing. The joints were cured underwater at room temperature for 24 hrs. Samples were removed from the water and bond strengths quantified as described above.

### Contact Angles

Aluminum substrates (8.90×1.27×0.16 cm) were cleaned using the same method to prepare underwater lap shear substrates. Polymer solutions were made at a concentration of 0.3 g/ml in MeOH/DCM 70:30 v/v for dry and DCM/MeOH 3:1 v/v for under seawater measurements. Polymer drops (45 μL) were deposited onto the submerged aluminum surface using a pos-D-pipette inside of a fish tank. Drop images were taken with a 15× macro lens attachment and an iPhone 8 camera. Contact angle measurements were taken with Image J using the angle tool for right and left edges that were averaged. Each set sample was repeated five times. Error bars are reported at 90% confidence.

### Results:

To determine the influence of positive charges upon bulk adhesion, dry adhesion was measured for each p[DMA-MMA-MAPTAC] derivative. Polymers with and without a periodate oxidative cross-linker, were examined (FIG. 1). When cross-linked, tetrabutylammonium periodate at a 3:1 catechol:IO₄⁻ ratio was used. Adhesion was measured in lap shear bond configurations given the generally more reproducible results that can be obtained. Aluminum is a generally common high-energy substrate. The results were compared with a reported cationic polystyrene-based polymer (see, e.g., White, J. D et al., Macromolecules, 2011, 44 (13), 5085-5088, which is hereby specifically incorporated by reference for its teaching regarding same).

FIG. 1A shows that p[DMA-MMA-MAPTAC] control polymer without charge bonded dry at 1.0 (±0.1) MPa. Adding cations increased adhesion to a peak at 11% charge with 1.9 (±0.4) MPa. Further cation addition decreased adhesion down to ˜0.8 MPa with the polymers containing 61% to 76% cationic charge.

FIG. 1B shows that when the IO₄⁻ cross-linker was added, the control polymer adhesion bonded at 2.4 (±0.4) MPa. Adding charges showed a less obvious trend than the analogous polymer without the cross-linker (FIG. 1A). Added cations showed decreased adhesion when cross-linked. The 61% charged polymer showed adhesion of 2.1 (±0.5) MPa.

These results indicate that, for dry bonding, and no cross-linker small degrees of charge inclusion increased bonding. Larger loadings of cations produced the opposite effect and performance decreased. When cross-linked, the general broad trend was lower adhesion with more cations. At least within this limited context, cations do not appear to be a significant promoter of adhesion.

Aluminum substrates have anionic surfaces. Increases in adhesion with added cations could be due to electrostatic forces between the polymer and the surface. Then further cations, over the limit of anions in the substrate, could then disrupt cohesive bonding via cation-cation repulsions. The polymer alone has a cohesive failure. Adding the cross-linker was likely to increase cohesive forces within the bulk and, consequently, may have increased the measured adhesion strength.

In general, measured adhesion for the cross-linked adhesives were higher than the polymer alone counterparts. Catechol-mediated cross-linking is a means of increasing molecular weights, albeit not a very precise approach. The molecular weights found for these polymers, in the range of ˜15,000-˜103,000 g/mol, tend to fall below those seen to be optimal for adhesion with a polystyrene-based catechol system. Thus higher adhesion with the addition of a cross-linker makes sense from this perspective. Synthesis of these polymers showed a mild trend of molecular weights increasing with higher cation loadings (Table 1). Adhesion data in FIG. 1 indicated a general decrease in performance with added cations.

A polystyrene-based system also reported dry adhesion with a periodate cross-linker. The uncharged control polymer had adhesion at 2.4 (±0.5 MPa), similar to the uncharged methacrylate control here. The 11% cationic polymers had a similar performance for the polystyrene derivative at 1.6 (±0.3) MPa and 1.7 (±0.3) MPa for the polymethacrylate here. A difference was seen in the 7% cationic content polymers. The polystyrene-based system showed 2.8 (±0.6) MPa and the polymethacrylate was at 1.1 (±0.3) MPa. With these dry conditions, neither system was strong ethyl cyanoacrylate SuperGlue (7±1 MPa) or poly(vinyl acetate) (4±1 MPa) Elmer's commercial product. Nonetheless, altering the backbone here allowed us to simplify the synthetic procedure to two steps from six, without compromising overall performance.

### Saltwater Adhesion

Subsequent studies were carried out under artificial sea water to further examine the influences of cations. When polymers contained more than ˜29% cations, the property of water solubility emerged. Thus the highest charge content derivatives of polymer simply dissolved into the surrounding water during wet bonding experiments. Consequently, data were collected from the 0-29% charge content derivatives. Data for bonding under salt water are presented in FIG. 2A. The uncharged, control polymer (1.0±0.1 MPa) showed similar adhesion to the dry conditions at 1.0 (±0.1) MPa. Bonding of the 7% derivative dropped to 0.6±0.3 MPa. Higher adhesion was then seen for 11% cation content, 0.9±0.3 MPa. Above 11% the adhesion decreased significantly, to less than ˜0.2 MPa.

The cross-linked, control, uncharged polymer exhibited significantly lower adhesion (0.1±0.1 MPa) than without the added cross-linker (1.0±0.1 MPa). Adding 7% cation (0.4±0.3 MPa) then 11% (1.1±0.4 MPa) recovered bonding up to the same level as the uncharged control. Even with added periodate, the 17%, 21%, and 29% polymers did not bond well at all.

Handing differences were noted when working with the various polymers. As the charge started increasing, the polymers became less tacky and more water-soluble. The uncharged control polymer formed a drop when added underwater. This drop did not stick well to the surface. When substrates were overlapped, the adhesive often slipped out. When applied cautiously, the solution could be maintained in place. The 7% charged polymer was tackier than the uncharged control but less tacky than the 11% charged version. The added tackiness of the 11% polymer made it easier to apply underwater than the uncharged control. The substrates held together well without needing much force. Charges above 11% started to form non-sticky gels when brought in contact with seawater. After 24 hours underwater, the bonding was low. After the 24 hour cure underwater, the control and 11% charged polymers were flaky and dry. By contrast, the higher-charge polymers were wet and could be easily wiped off the substrates. Solvent diffusion into the seawater may have occurred for the 0-11% polymers. On the contrary, higher charge content may have caused water to diffuse into the polymer. Adhesion at 11%, positive charge may demonstrate that having some charge aids with performance, but too much charge can bring unwanted consequences.

### DI-Water Adhesion Testing

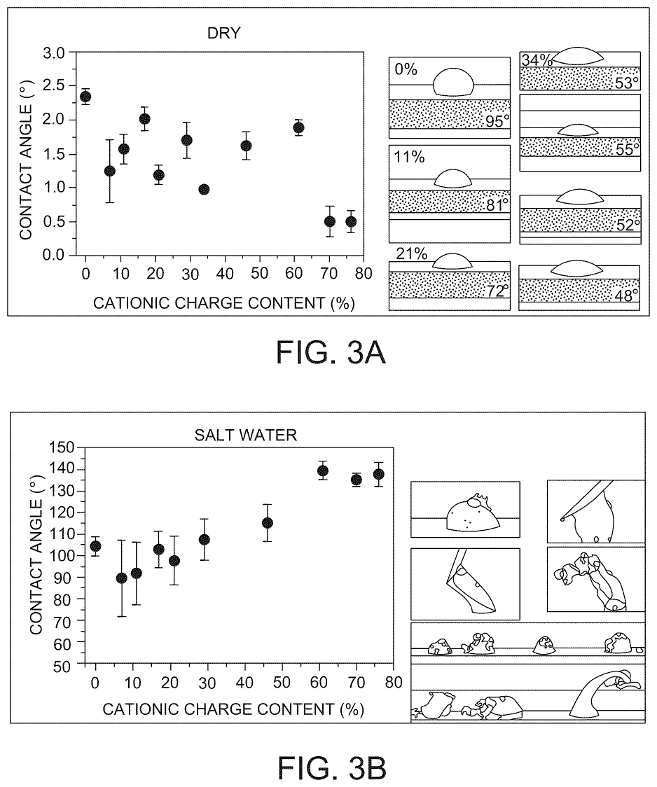

Comparing underwater bonding in seawater versus deionized water may be able to provide insights regarding the importance of cations displaced surface-bound ions. FIG. 3B shows analogous underwater bonding in deionized water. The control polymer showed adhesion of 1.4±0.4 MPa. There was then a significant decrease in performance when the cationic charge increased. Above 11% charge adhesion was not observed. When adding the periodate cross-linker, similar behavior was noted to that of salt water. The cross-linker solution mixed homogenously with the uncharged control polymer drop but did not mix well with the cationic charge polymer solutions. Likewise, when applying the polymer drops onto substrates, the control polymer slipped off the substrate easily and more so than in salt water. After 24 hours, the adhesive was dry and flaky. For the solutions of charged polymers in deionized water, the solutions swelled, and solids often precipitated out. After 24 hours under deionized water, the charged polymers appeared swollen, likely having absorbed water and pink in the edges.

Perhaps the most interesting finding here was generally lower adhesion for cationic polymers in deionized water than in seawater. Amongst the many challenges of making adhesives for performing in seawater is having the ability to displace surface-bound ions to enable attachment to substrates. Such a concern might predict bonding in salt water to be more difficult than in deionized water. The opposite was true for polymers examined here. These data may indicate that surface-bound ions may be low on the list of concerns when designing new underwater adhesives.

### Saltwater Versus Deionized Water

### Contact Angles

To better understand how these adhesive polymers interact with surfaces, contact angle measurements were taken. Contact angles were studied both in air and wander salt water. Bare aluminum substrates, similar to those used for underwater for adhesion testing, were used. FIG. 3A, shows the dry contact angle data for each polymer in MeOH:DCM 70:30 solvent. Without any cationic charge, the control polymer showed 97±2°. All charged percents then had lower contact area values. Although a clean trend was not found, these data indicate that, in general, increasing cation content in the polymer decreased contact angles. Such an observation indicates that, with these dry conditions, cations promote bonding to the anionic aluminum surfaces. Bulk adhesion requires a good balance of surface bonding and cohesion in the bulk material. Dry adhesion data (FIG. 1A) indicated that cations tended to decrease overall performance. These contact angle data imply that cations are actually contributing to beneficial interactions at surfaces. This can be concluded that the detrimental performance characteristics of cations in dry bonding are a manifestation of cohesive interactions.

Contact angle studies under salt water necessitated a change to DCM:MeOH 3:1 solvent. Work here is challenging when polymer solutions tend to stick to the pipette tip when ejected. The uncharged control polymer was an exception here, not sticking to the plastic pipette. The 11% cation solution was more sticky. Progressively higher cation loadings made polymers difficult to eject from the pipette tip, and at 46% and above, the polymers dissolved into the surrounding water. However, this dissolution was not immediate.

Nonetheless, data could be obtained and are shown in FIG. 3B. A trend of higher cation content gave rise to higher contact angles. Cations appear to decrease the ability of the polymers to bind aluminum, surfaces. One potential conclusion here is that cations may not be doing much to enhance surface attachment in the face of salt water. Based on the bulk adhesion data, performance was higher in salt water (FIG. 2A) than in deionized water (FIG. 2b). If cations interact less with salty surfaces (FIG. 3B), but salt promotes bulk bonding (FIG. 2A versus 2B), we may suggest that the relevant forces at play are cohesive in nature. Perhaps high salt concentrations can shield cations with chloride anions, thereby enabling cationic polymers to approach closely for cohesive bonding. Dry adhesion showed a generally detrimental influence of higher cation loadings (FIG. 1A). Viewed from an analogous perspective, salt may prevent detrimental cation-cation repulsions within the bulk material. However, these studies are carried out in the water, which is generally hostile toward adhesion.

Given that the charge in the polymer increases its hydrophilicity, the contact angles confirm this property. In addition to the polymer properties, the high-energy nature of aluminum contributes to the increase in wetting with an added charge.

In addition, any of the embodiments described in the following clause list are considered to be part of the invention.

A. An adhesive polymer comprising (i) a catechol-containing monomer, (ii) a filler monomer, and (iii) a cation-containing monomer.

B. The adhesive polymer of clause A, wherein the adhesive polymer further comprises a cross-linker.

C. The adhesive polymer of clause A or B, wherein the cation-containing monomer comprises quaternary alkyl ammonium cation.

D. The adhesive polymer of clause C, wherein the cation-containing monomer is selected from [3-(methacryloylamino)propyl] trimethylammonium chloride (MAPTAC), [2-(methacryloyloxy)ethyl] trimethylammonium chloride (METAC), and (3-acrylamidopropyl) trimethylammonium chloride (APTAC).

E. The adhesive polymer of clause D, wherein the cation-containing monomer is present in a proportion of about 5 mol % to about 80 mol % of the polymer.

F. The adhesive polymer of clause A or B, wherein the catechol-containing monomer is selected from dopamine acrylamide (DA) and dopamine methacrylamide (DMA).

G. The adhesive polymer of clause F, wherein the catechol-containing monomer is present in a proportion of about 10 mol % of the polymer.

H. The adhesive polymer of clause A or B, wherein the filler monomer is selected from methyl acrylate (MA), methyl methacrylate (MMA) and N-[3-(dimethylamino)propyl] methacrylamide (DMAPMA).

I. The adhesive polymer of clause H, wherein the filler monomer is present in a proportion of about 85 mol % to about 10 mol % of the polymer.

J. The adhesive polymer of clause B, wherein the cross-linker is sodium periodate, tetrabutylammonium periodate, iron(II) nitrate, iron(III) acetonylacetonate, potassium permanganate, di-tert-butyl peroxide, hydrogen peroxide, cumene hydroperoxide, 2-butanone hydroperoxide, potassium ferrate, chromate, dichromate, or any combination thereof.

K. A method of synthesizing the adhesive polymer of clause A, wherein the synthesis comprises:
(i) dissolving a catechol-containing monomer with a filler monomer and an initiator in a non-aqueous solvent to provide a solution of monomers;
(ii) mixing an aqueous solution of cation-containing monomer with the solution of monomers of step (i);
(iii) allowing a polymerization reaction to occur; and
(iv) quenching a reaction mixture to obtain the adhesive polymer.

L. The synthesis of clause K, wherein the non-aqueous solvent is selected from methanol, dichloromethane, chloroform, N, N dimethylformamide, acetone, acetonitrile, dimethylsulfoxide or a combination thereof.

M. The synthesis of clause K or L, wherein methanol and water used in a ratio of about 70:30 v/v.

N. The synthesis of clause K, wherein the initiator is selected from dibenzoyl peroxide (BPO), tert-butyl peroxide, diacetyl peroxide, lauroyl peroxide, dicumyl peroxide, 2,2′-azobisisobutyronitrile (AIBN), 2,2′-azobis(2-methylpropionitrile), 2,2′-azobis(2-methyl butyronitrile), or a combination thereof.

As used herein, the following terms and phrases shall have the meanings set forth below. Unless defined otherwise, all technical and scientific terms used herein have the same meaning as commonly understood to one of ordinary skill in the art.

The term “about” can allow for a degree of variability in a value or range, for example, within 10%, within 5%, or within 1% of a stated value or of a stated limit of a range.

The term “substantially” can allow for a degree of variability in a value or range, for example, within 90%, within 95%, or within 99% of a stated value or of a stated limit of a range.

The terms “a,” “an,” or “the” are used to include one or more than one unless the context clearly dictates otherwise. The term “or” is used to refer to a nonexclusive “or” unless otherwise indicated. In addition, the phraseology or terminology employed herein, and not otherwise defined, is for the purpose of description only and not of limitation. Any use of section headings is intended to aid reading of the document and is not to be interpreted as limiting. Further, information that is relevant to a section heading may occur within or outside of that particular section. The terms “including” and “having” are defined as comprising (i.e., open language).

Those skilled in the art will recognize that numerous modifications can be made to the specific implementations described above. The implementations should not be limited to the particular limitations described. Other implementations may be possible.

It is intended that the scope of the present methods and apparatuses be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

1. An adhesive polymer comprising (i) a catechol-containing monomer, (ii) a filler monomer, and (iii) a cation-containing monomer.

2. The adhesive polymer of claim 1, wherein the adhesive polymer further comprises a cross-linker.

3. The adhesive polymer of claim 1, wherein the cation-containing monomer comprises quaternary alkyl ammonium cation.

4. The adhesive polymer of claim 3, wherein the cation-containing monomer is selected from [3-(methacryloylamino)propyl] trimethylammonium chloride (MAPTAC), [2-(methacryloyloxy)ethyl] trimethylammonium chloride (METAC), and (3-acrylamidopropyl) trimethylammonium chloride (APTAC).

5. The adhesive polymer of claim 4, wherein the cation-containing monomer is present in a proportion of about 5 mol % to about 80 mol % of the polymer.

6. The adhesive polymer of claim 1, wherein the catechol-containing monomer is selected from dopamine acrylamide (DA) and dopamine methacrylamide (DMA).

7. The adhesive polymer of claim 6, wherein the catechol-containing monomer is present in a proportion of about 10 mol % of the polymer.

8. The adhesive polymer of claim 1, wherein the filler monomer is selected from methyl acrylate (MA), methyl methacrylate (MMA) and N-[3-(dimethylamino)propyl] methacrylamide (DMAPMA).

9. The adhesive polymer of claim 8, wherein the filler monomer is present in a proportion of about 85 mol % to about 10 mol % of the polymer.

10. The adhesive polymer of claim 2, wherein the cross-linker is sodium periodate, tetrabutylammonium periodate, iron(III) nitrate, iron(III) acetonylacetonate, potassium permanganate, di-tert-butyl peroxide, hydrogen peroxide, cumene hydroperoxide, 2-butanone hydroperoxide, potassium ferrate, chromate, dichromate, or any combination thereof.

11. A method of synthesizing the adhesive polymer of claim 1, wherein the synthesis comprises:
(i) dissolving a catechol-containing monomer with a filler monomer and an initiator in a non-aqueous solvent to provide a solution of monomers;
(ii) mixing an aqueous solution of cation-containing monomer with the solution of monomers of step (i);
(iii) allowing a polymerization reaction to occur; and
(iv) quenching the polymerization reaction to obtain the adhesive polymer.

12. The synthesis of claim 11, wherein the non-aqueous solvent is selected from methanol, dichloromethane, chloroform, N, N dimethylformamide, acetone, acetonitrile, dimethylsulfoxide or a combination thereof.

13. The synthesis of claim 11, wherein methanol and water are used in a ratio of about 70:30 v/v.

14. The synthesis of claim 11, wherein the initiator is selected from dibenzoyl peroxide (BPO), tert-butyl peroxide, diacetyl peroxide, lauroyl peroxide, dicumyl peroxide, 2,2′-azobisisobutyronitrile (AIBN), 2,2′-azobis(2-methylpropionitrile), 2,2′-azobis(2-methyl butyronitrile), or a combination thereof.
